(19) United States
(12) Patent Application Publication
(10) Pub. No.: US 2018/0053179 A1
(43) Pub. Date: Feb. 22, 2018

(54) Method and System to Enable Mobile Contactless Ticketing/Payments Via a Mobile Phone Application

(71) Applicants: Bankinter S.A., Madrid (ES); Seglan S.L., Madrid (ES)

(72) Inventors: Carlos Alberto Perez Lafuente, Madrid (ES); Imanol Garcia Murga, Madrid (ES)

(21) Appl. No.: 15/783,297

(22) Filed: Oct. 13, 2017

Related U.S. Application Data
(62) Division of application No. 14/422,555, filed on Feb. 19, 2015.

(30) Foreign Application Priority Data
Aug. 21, 2012 (ES) P 201200837
Feb. 15, 2013 (ES) P 201300165
Mar. 6, 2013 (ES) P 201300230
Aug. 1, 2013 (ES) P 201300717

(51) Int. Cl. G06Q 20/32; G06Q 20/40; G06Q 20/38; G06F 21/33; H04L 29/06; H04W 4/00

(52) U.S. Cl. CPC G06Q 20/3278; G06Q 20/4012; G06Q 20/322; G06Q 20/3821; H04W 4/008; H04L 63/0807; H04L 63/0492; G06F 2221/2137; H04L 2463/102; G06F 21/335

(57) ABSTRACT

A method for mobile contactless ticketing/payment using an application available in a mobile phone; and a system, server, and mobile phone suitable for carrying out such a method.

This invention relates to a method for mobile contactless ticketing/payments, using an application available at the mobile phone. This invention relates also to a system, a server and a mobile phone suitable for carrying out such a method.

### BACKGROUND ART

Development of ticketing solutions using smart cards has had a significant growth along the last decade in a significant number of markets. Migration from contact to contactless smart cards for ticketing applications started years ago, while using NFC (Near Field Communications) mobile phones for ticketing is currently in an early stage.

Payments are leading the number of NFC initiatives world-wide but there is still uncertainty about the time frame for wide availability of contactless Point Of Sale terminals at merchant's locations.

The growing number of available NFC-enabled handsets makes services providers and NFC ecosystem parties to ambition a promising mobile phone ticketing/payment business and channel. No doubt that the mobile phone offers the user, in comparison with contactless smart card solutions, an improved experience in terms of user interface and remote provisioning.

Most popular mobile contactless solutions for ticketing/payments are so called “SIM based”, which means that transportation/payments application and user credentials are stored in a SIM card secure element, owned by the corresponding telecommunication operator; so in this context transportation/payment service providers shall reach an agreement with the telecommunications operator to provide NFC ticketing/payment services; thus transportation/payment service providers may be limited in the way the provide their own services via the mobile phone as, using this solution, part of the service is provided within the telecommunications operator domain.

It can therefore be of interest for service providers to have access to new secure solutions that can be fully available within the transportation/payment entity own domain, but still endowed with all the benefits provided by contactless ticketing/payments based on the use of NFC mobile phones.

### DISCLOSURE OF THE INVENTION

An object of the invention is therefore to provide to transportation/payment service providers with a secure method that can be entirely performed at their own domain, so helping them to continue keeping full control of their service branding, business and provisioning for NFC mobile ticketing/payments, avoiding third party restrictions.

This object is achieved in accordance with claim 1 by providing a method to enable mobile contactless ticketing/payments via a mobile phone application, the method comprising the following steps:
(a) A user pays to the service provider for certain ticketing/payment services.
(b) Associated to the payment and to the corresponding granted right to use related ticketing/payment services, a ticketing/payments server module prepares ticketing/payment credentials for use by the registered user and send them to the registered user mobile phone.
(c) The user mobile phone receives the credentials and stores them for use at the transportation contactless ticketing system, in case of ticketing credentials, or for use on mobile contactless payments, in case of payment credentials.

The said method is characterized in that each credential is univocally associated to the registered user mobile phone and to an activation code and partly enables the mobile phone for contactless ticketing access, in case of ticketing credentials, or for mobile contactless payments, in case of payment credentials; where mobile phone enablement for each contactless ticketing access (or mobile contactless payment) also requires the user inserting a Personal Identification Number (PIN) at the mobile phone ticketing/payment application; the ticketing/payments server module send credentials to the registered user mobile phone after successful validation of a One Time Password (OTP) received from the mobile phone ticketing/payments application.

According to the present invention only registered users can obtain ticketing/payment credentials after payment, and usage of such credentials is associated to the mobile phone selected at the registration process (and to an activation code) and to a Personal Identification Number selected by the user, so two factors authentication is required. On top of that, credentials are only sent to the registered user mobile phone application after verifying an OTP generated by such mobile phone application after user interaction so credentials downloading process is properly controlled by the user and by the transportation/payments service provider.

The ticketing/payments server module may be at least partly included in the data processing means of the service provider. All of it or part of it may be own or operated by a trusted external provider of the service provider. As an example, several transportation service providers may share a common ticketing server module by just reaching an agreement between them, avoiding the complexity of SIM-based solutions in terms of additional agreements with telecommunications operators;

In a particular embodiment, the ticketing/payments server module divides the granted ticketing/payment right into several partitions and generates an independent credential for each one of those partitions.

In a particular embodiment, a first set of credentials is sent to the mobile phone application, and new credentials are sent to the mobile phone application when successively requested from the user mobile device, up to the limit of the granted right to use contactless ticketing/payment services. Thus the system can monitor and limit at any time the number of credentials available at the mobile phone for ticketing access/payments.

In a particular embodiment, at least one credential is disabled at (or deleted from) the mobile phone application by sending a disabling (or deleting) message from the ticketing/payments server module to the user mobile phone application.

In other particular embodiment, the right to use ticketing/payment services can be extended by the user paying for it, so new ticketing/payment right partitions can be dynamically generated at the ticketing/payments server module.

In another particular embodiment, the mobile phone application limits the request of new credentials based on information about the credentials that are already stored into the mobile phone. So if e.g. the number of credentials is below a threshold, the user is reminded that data connectivity is required for new credentials availability.

In a particular embodiment, ticketing/payment credentials are blocked at the mobile phone application after a number of wrong insertions of the Personal Identification Number, and an advice message is sent to the ticketing/payments server module.

In a particular embodiment, the ticketing/payments server module blocks the granted ticketing/payments right after a number of wrong verifications of an OTP received from the mobile phone application, and a credentials blocking message is sent to the mobile phone application.

Thus the transportation/payments entity can monitor wrong PIN insertions happening just previously to a ticketing access/payment attempt or those occurring within a credentials renewal process.

In a particular embodiment, for on-line mobile contactless payment transactions a second part of the credential is calculated by the mobile phone application itself, using the transaction value and the user PIN as inputs to generate a OTP result (the second part of the credential). The first and the second part of the credential are used for the mobile contactless payment transaction and verification of such OTP by the payment server module is required in order to accept or deny the transaction. So taking advantage of the fact that transaction value is known by the issuer bank during the on-line transaction process, the challenge for this OTP can use it and still be verified as part of the on-line authorization process.

In other particular embodiment for on-line mobile contactless payment transactions a second part of the credential is calculated by the mobile phone application itself, using the user PIN as input to generate a OTP result being the second part of the credential, where the first and the second part of the credential are used for the mobile contactless payment transaction and verification of such OTP by the payment server module is required in order to accept or deny the transaction. This embodiment requires the user to insert the PIN (but not the transaction value) for the OTP result calculation, so the payment preparatory process via the mobile phone payment application is simpler than in the previous embodiment.

In a particular embodiment a mobile contactless on-line payment transaction that uses the first and the second part of the credential has already been accepted (“the first transaction”) and at least one additional transaction that later uses at least part of the same first and second part of the credential (“the successive transactions”) is accepted based on the OTP verification of the first transaction.

As a particular example, on top of an initial mobile contactless on-line payment (or a payment preauthorization), merchants such as hotels, rent-a-car companies, etc. sometimes later charge the user with certain additional costs (e.g. the rent-a car company charges consumed petrol to the user). This embodiment allows the payments server module to enable acceptance of the successive transactions based on the electronic signature of the first transaction (successful OTP verification associated to the first transaction).

In a particular embodiment each of the successive transactions are matched to the first transaction based on the use of the at least part of the first and the second part of the credential.

In other particular embodiment each of the successive transactions are matched to the first transaction based on the use of the at least part of the first and the second part of the credential and the use of at least one additional parameter, this parameter being included in the transaction flow of the first and the successive transactions. In a particular example the at least one additional parameter is the merchant code.

In a particular embodiment there are a predefined maximum number of credentials stored into the mobile phone at a given time and the mobile phone application limits mobile contactless off-line payments using those credentials up to maximum off-line payments aggregated transaction value. So making off-line payments for an aggregated higher value requires the user correctly inserting the PIN value, such that the payments server module will send new credentials to the registered user mobile phone and the mobile phone payment application will set again the off-line payments aggregated transaction value to the maximum.

In a particular example the maximum number of credentials is x and the maximum aggregated value for off-line transactions using those credentials is yy euro. If the user makes an off-line mobile contactless payment for z euro, the maximum off-line payments amount using the remaining (x−1) credentials is (yy−z) euro. The mobile phone payment application requests new credentials; if the OTP verification at the payments server module is correct, a new credential is sent to the mobile phone payment application and the maximum aggregated transaction value for off-line payments is set again to yy euro.

In a particular embodiment the user selects through his mobile phone payment application to make an internet payment and the second part of the credential together with at least a part of the first part of the credential are used to perform such payment. So in this way the user may select via his mobile phone payment application a subset of a partly calculated credential, to make an internet payment.

In a particular embodiment an internet transaction that uses at least a part of the first part of the credential and the second part of the credential has already been accepted (“the first transaction”) and at least one additional transaction that later uses the same at least a part of the first part of the credential and the second part of the credential (“the successive transactions”) is accepted based on the OTP verification of the first transaction.

In a particular embodiment each one of the successive transactions is linked to the first transaction based on the use of the at least a part of the first part of the credential and the second part of the credential.

In a particular embodiment each one of the successive transactions is linked to the first transaction based on the use of the at least a part of the first part of the credential and the second part of the credential and the use of at least an additional parameter, being this parameter included into the transaction flow of the first and the successive transactions.

In a particular embodiment, the user pays for certain products and/or services at one or several associated merchants, and the at least one merchant transfers part of those transactions amounts to the provider of ticketing/payments services in order this one will offer certain ticketing/payments services to the user. So in this embodiment, the at least one merchant manages the payment of those transactions amounts on behalf of the user, in the context of a loyalty program offered by the merchant(s).

Typically, the loyalty programs offered by merchants provide the user with points, accumulated after each purchase, and those can only be redeemed at a reducer set of associated merchants. The previous embodiment allows to the at least one merchant offering to its customer (as a loyalty tool) ticketing/payment services whose usage scope is much wider than the one of the referred reduced set of merchants.

In a particular implementation the user can utilize his mobile phone payment application to pay at merchants up to the limit of the transactions amounts accumulated as a result of the different purchases at the at least one merchant. Note that those payments could be performed at a multiplicity of merchants without the need of any agreement between the at least one merchant where the original purchases have been made and the merchants where payments are made using those accumulated transactions amounts.

In another particular implementation the accumulated transactions amounts are used to grant the user certain rights to use ticketing services. So the user will be able to use his mobile phone ticketing application to access to ticketing services at a multiplicity of access points (e.g. to access to any city bus).

In a particular embodiment one or several merchants pay to the provider of ticketing/payment services for certain ticketing/payment services for the user, in the context of a loyalty program offered by the merchant(s), Likewise, when the user pays for certain products and/or services at the at least one merchant, the at least one merchant transfers part of those transactions amounts to the provider of ticketing/payment services in order this one will offer certain ticketing/payment services to the user. Similarly to the previous embodiment, in this embodiment the at least one merchant manages the payment of those services and those transactions amounts on behalf of the user, in the context of a loyalty program offered by the merchant(s).

In a particular embodiment there is a maximum predefined number of the first part of a set of credentials for mobile contactless off-line payments that can be stored into the mobile phone at a given time instant and, once the validity period of the first part of each one of those credentials expires, the mobile phone payment application limits the mobile contactless off-line payments that uses that first part of each one of those credentials. So, to perform mobile contactless off-line payments once that first part of the set of credentials for mobile contactless off-line payments has expired, the user must correctly insert the PIN value, such that the payments server module will send new valid first parts of credentials for mobile contactless off-line payments to the registered user mobile phone.

Patent WO 03/038719 describes a method where a one-time use virtual financial card is off-line generated, to be used for an internet payment or a contactless EMV-MSD-type (magnetic stripe data) transaction. But such solution cannot be utilized to generate a one-time use virtual financial card for a contactless EMV chip & PIN type transaction, due to the fact a derived key shall be calculated at server side and sent to the mobile phone application prior to the payment attempt (in order to avoid storing the issuer key at the mobile phone); so generation of a one-time use virtual financial card for a contactless EMV chip & PIN transaction requires to handle an on/off-line process for each generated card. The last embodiment above match the on-line updating requirement but advantageously also associates a mobile off-line generated second part of the credential to the transaction value and the user PIN thus creating a convenient and highly robust payment solution.

According to the present invention, there is further provided a system to enable mobile contactless ticketing/payments via a mobile phone application, said system comprising:
registering means for registering users for ticketing/payment services,
payment means to allow user to pay for ticketing/payment services,
credentials generation means to prepare at the ticketing/payments server module, and based on granted ticketing/payment rights, ticketing/payment credentials for use by the registered user; and transmission means to send them to the registered user mobile phone; and reception and storage means to receive at the mobile phone the credentials and store them for use at the transportation contactless ticketing system (or for use on mobile contactless payments, in case of payment credentials),
   characterized in that the said mobile system comprises processing means to univocally associate each credential that partly enables the mobile phone for contactless ticketing access (or for mobile contactless payments), to the registered user mobile phone and to an activation code; processing and checking means to allow mobile phone enablement for each contactless ticketing access (or mobile contactless payment), that is also based on the user inserting a Personal Identification Number (PIN) at the mobile phone ticketing/payment application; processing and transmission means at the mobile phone ticketing/payment application to calculate a OTP and sent it to the ticketing/payments server module; and processing and verification means at the ticketing/payments server module to validate the received OTP.

### BRIEF DESCRIPTION OF THE DRAWINGS

In the following detailed description of some possible embodiments, other features and advantages of the invention will appear, each description being made with reference to the following drawings:

FIG. 1.a is a schematic diagram that generally illustrates the main functional blocks of the invention, as an extension of a legacy transportation system;

FIG. 1.b is a schematic diagram illustrating an embodiment of a ticketing system according to the invention;

FIG. 1.c is a schematic diagram illustrating another embodiment of a ticketing system according to the invention;

FIG. 2.a is a schematic diagram that generally illustrates the main functional blocks of the invention, as an extension of a legacy payment system;

FIG. 2.b is a schematic diagram illustrating an embodiment of a payment system according to the invention;

FIG. 2.c is a flow chart illustrating partly an embodiment of a method according to the invention;

FIG. 2.d is a flow chart illustrating partly an embodiment of a method according to the invention;

FIG. 2.e is a flow chart illustrating partly an embodiment of a method according to the invention;

FIG. 2.f is a flow chart illustrating partly an embodiment of a method according to the invention;

FIG. 2.g is a flow chart illustrating partly an embodiment of a method according to the invention;

### DETAILED DESCRIPTION

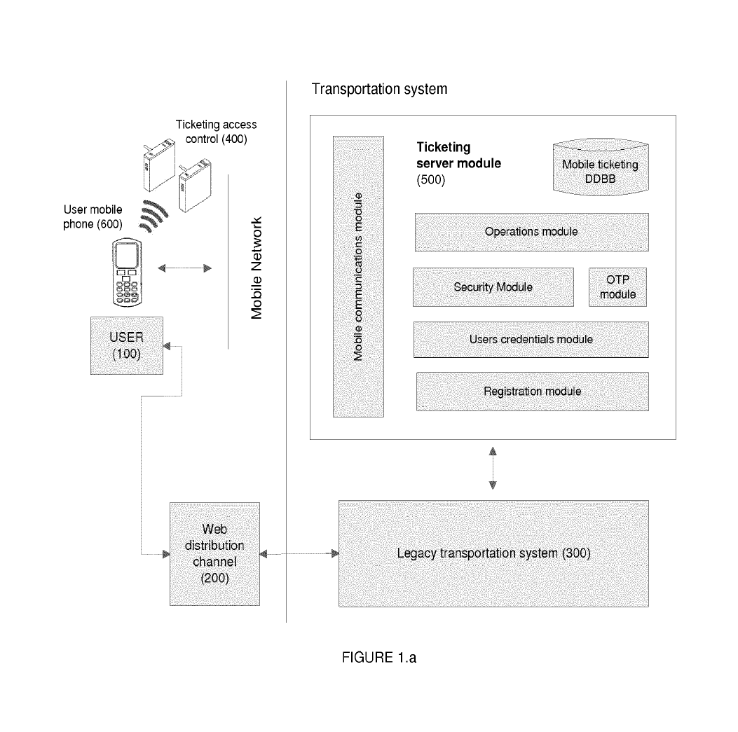

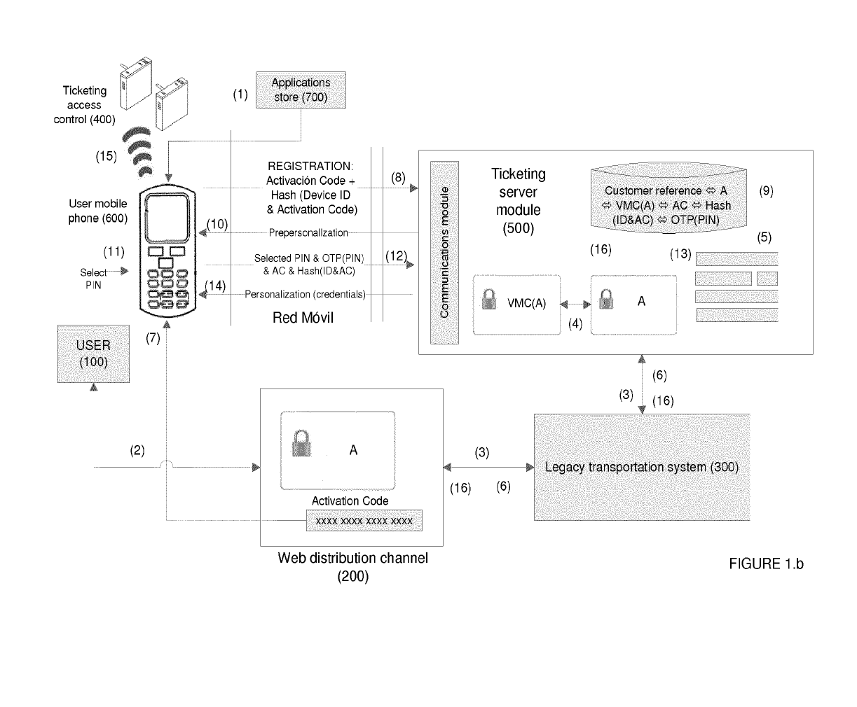

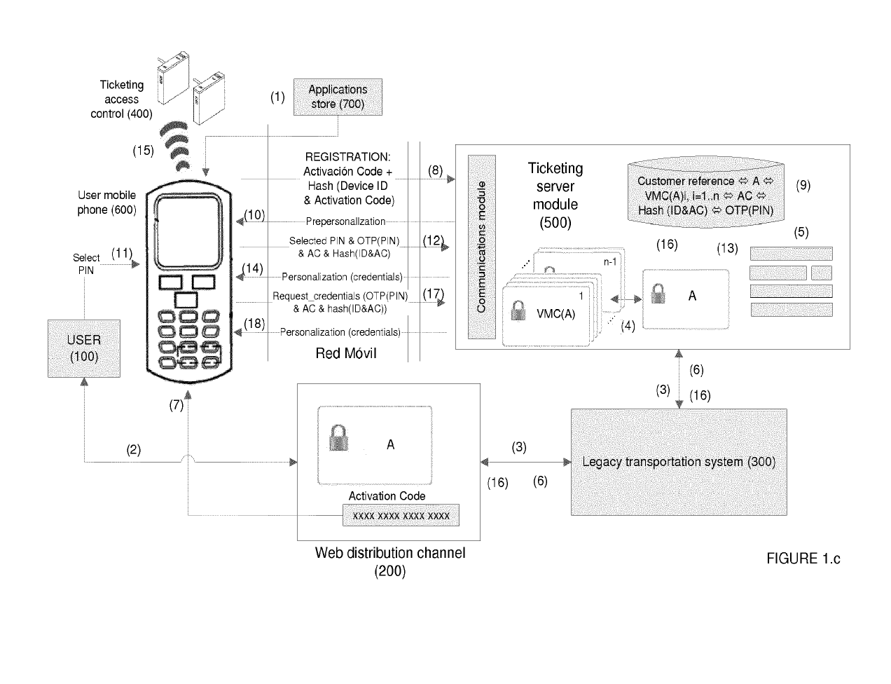

FIG. 1.a is a schematic diagram that generally illustrates the main functional blocks of the invention, as an extension of a legacy transportation system; this figure shows a legacy transportation system 300a from a service provider, supporting contactless smart cards (so a user of this system may have available a contactless smart card to access to transportation services via ticketing access control 400a devices). By using the web distribution channel 200a users 100a can make necessary arrangements to contract at least one service, to get at least one transportation title (profile) associated to such at least one service and to load/reload the at least one transportation title. In this general example the web distribution channel belongs to a partner bank and the user is also customer is this bank, so he can pays via the web page using an electronic signature media provided by the bank.

When the user requests, via the web distribution channel, the mobile ticketing services related to the present invention (and pays for them according to an agreed method between e.g. the referred bank and the ticketing service provider) the legacy transportation system forward the request to the ticketing server module 500a of the invention. Main functional blocks of this module are illustrated in this figure.

FIG. 1.b provides further details about the functional blocks of FIG. 1.a and is a schematic diagram illustrating an embodiment of a ticketing system according to the invention, to enable mobile contactless ticketing via a mobile phone application; FIG. 1.b shows the process from user registration for mobile ticketing services up to the provision of those services.

In step (1) the user downloads the ticketing mobile phone application from an applications store 700 into his contactless enabled mobile phone.

In the context of the invention, the user pays for certain ticketing services requested to the services provider. In step (2) of this embodiment, the user requests ticketing services via a web distribution channel and confirm payment via this media (e.g. same scenario than the one described in FIG. 1.a: the web distribution channel belongs to a partner bank). In step (3) the request is sent to the legacy transportation system and then forwarded to the ticketing server module. In this embodiment the registration module of the ticketing server module receives in step (3) a customer reference and a transportation right reference.

Associated to the payment and to the corresponding granted right to use related ticketing services, a ticketing server module prepares ticketing credentials for use by the registered user and send them to the registered user mobile phone, as detailed herein below.

In step (4) the registration module of the ticketing server module assigns a transportation right to the user (represented in FIG. 1.b as card “A” into the server module), based on the received transportation right reference, and these information is stored at the ticketing server module database (customer reference [symbol] A). Then the registration module request to the users credentials module to generate a single credential (represented in FIG. 1.b as card “VMC(A)” into the server module) and it is linked to the transportation customer reference and the transportation right at the ticketing server module database (customer reference [symbol] A [symbol] VMC(A)). The generated credential has an expiry date so that it cannot be used after expiration.

In step (5) the user credentials module request to the security module for an activation code; so an activation code with a given expiry date is generated by the security module and stored into the ticketing server module database (customer reference [symbol] A [symbol] VMC(A) [symbol] AC). An activation code cannot be used after expiration. In step (6) the activation code is sent from the registration module to the legacy transportation system, forwarded to the web distribution channel and displayed to the user.

In step (7) the user inserts the activation code into the ticketing mobile phone application and in step (8) the mobile phone sends to the security module of the ticketing server module, e.g. via https, the [activation code and the hash(mobile phone identity number & activation code)].

In step (9) the security module checks if the activation code is correct; if so, the security module stores the hash value at the ticketing server module database, so that the links are now as follows: customer reference [symbol] A [symbol] VMC(A) [symbol] AC [symbol] hash(ID&AC).

In step (10) card “A” is pre personalized at the mobile phone application.

Pre personalization refers to the step previous to personalization; and card “A” pre-personalization/personalization refers to pre-personalization/personalization of the mobile contactless ticketing application of the invention to operate in “card emulation mode” for mobile contactless ticketing services, equivalently to a SIM based ticketing application operating in “card emulation mode” for mobile contactless ticketing services (e.g. emulating mifare DESFIRE underlying technology). Card “A” full personalization at the mobile phone ticketing application requires downloading credentials from the ticketing server module to the mobile phone ticketing application, as described herein below.

When step (10) ends the user is already registered into the system of the invention, but receiving credentials at the mobile phone ticketing application is still pendent. At this stage, each credential is univocally associated to the registered user mobile phone and to an activation code and partly enables the mobile phone for contactless ticketing access.

In step (11) the user is prompted to select a Personal Identification Number (PIN) for mobile contactless ticketing services. The PIN value is not stored at the ticketing mobile phone application but is securely sent in step (12) to the security module of the ticketing server module, together with a One-Time-Password (OTP) calculated using the PIN value (and the Activation Code and hash(AC&ID) values, to be able to assign at the ticketing server module the selected PIN and the OTP result to the right customer reference).

In step (13) the security module stores the PIN at the ticketing server module data base, together with the keys and parameters to calculate a PIN-based OTP result. All this storage is labelled in FIG. 1.b data base as “OTP(PIN)” data. So that the links and storage at the data base are now the following: customer reference [symbol] A [symbol] VMC(A) [symbol] AC [symbol] hash(ID&AC) [symbol] OTP(PIN).

Still in step (13), the ticketing server module calculates an OTP result using the stored user PIN and OTP keys and parameters, and compares the result with the one received at the security module from the mobile phone ticketing application. If validation is successful then ticketing credentials can be sent from the user credentials module to the mobile phone ticketing application. So the ticketing server module send credentials to the registered user mobile phone after successful validation of a One Time Password (OTP) received from the mobile phone ticketing application.

In step (14) the ticketing credentials are sent to the mobile phone ticketing application; the user mobile phone receives the credentials and stores them for use at the transportation contactless ticketing system (so card “A” personalization process is then completed). In one embodiment credentials have been ciphered at the security module using the PIN, so in order the mobile phone ticketing application can use a received and stored credential it is required that the user will insert his PIN code.

The registered user can in step (15) use the mobile phone to access to transportation services. In step (15) the user shall insert his PIN code at the mobile phone ticketing application before trying to access to the ticketing access control system 400; so mobile phone enablement for each contactless ticketing access also requires the user inserting a personal identity code (PIN) at the mobile phone ticketing application.

In step (16) the user credentials module of the ticketing server module is aware that ticketing credentials have been successfully received and stored at the mobile phone ticketing application (success on step 14) so confirmation is sent to the web distributor, that makes payment final charge and inform the user (e.g. via an SMS or a distributor web page alert).

FIG. 1.c is a schematic diagram illustrating another embodiment of a ticketing system according to the invention, to enable mobile contactless ticketing via a mobile phone application; FIG. 1.c shows the process from user registration for mobile ticketing services up to the provision of those services.

This embodiment takes as reference the one of FIG. 1.b with certain variances described hereinafter. Steps (1), (2) and (3), are the same than in FIG. 1.b.

Associated to the payment and to the corresponding granted right to use related ticketing services, a ticketing server module prepares ticketing credentials for use by the registered user and send them to the registered user mobile phone, as detailed herein below. But in this embodiment the ticketing server module divides the granted ticketing right into several partitions and generates an independent credential for each one of those partitions.

So in step (4) the ticketing server module assigns a transportation right to the user (represented in FIG. 1.c as card “A” into the server module), linked to a set of credentials (represented in FIG. 1.c as cards “VMC(A)₁” to “VMC(A)ₙ” into the server module) and to a transportation customer reference and stores these links into the ticketing server module database (customer reference [symbol] A [symbol] VMC(A)ᵢ, i=1 . . . n).

In step (5) an activation code is generated and stored into the ticketing server module database (customer reference [symbol] A [symbol] VMC(A)ᵢ, i=1 . . . n [symbol] AC). In step (6) the Activation code is sent to the legacy transportation system, forwarded to the web distribution channel and displayed to the user.

Steps (7), (8) and (9) are the same than in FIG. 1.b, so that the links after step (9) are as follows: customer reference [symbol] A [symbol] VMC(A)ᵢ, i=1 . . . n [symbol] AC [symbol] hash(ID&AC).

In step (10) card “A” is pre personalized at the mobile phone application.

As in embodiment 1.b, pre personalization refers to the step previous to personalization; and card “A” pre-personalization/personalization refers to pre-personalization/personalization of the mobile contactless ticketing application of the invention to operate in “card emulation mode” for mobile contactless ticketing services, equivalently to a SIM based ticketing application operating in “card emulation mode” for mobile contactless ticketing services. Card “A” full personalization at the mobile phone ticketing application requires downloading credentials from the ticketing server module to the mobile phone ticketing application, as described herein below.

When step (10) ends the user is already registered into the system of the invention, but receiving credentials at the mobile phone ticketing application is still pendent. At this stage, each credential is univocally associated to the registered user mobile phone and to an activation code and partly enables the mobile phone for contactless ticketing access.

In step (11) the user is prompted to select a Personal Identification Number (PIN) for mobile contactless ticketing services. The PIN value is not stored at the ticketing mobile phone application but is securely sent in step (12) to the ticketing server module, together with a One-Time-Password (OTP) calculated using the PIN value (and the Activation Code and hash(AC&ID) values, to be able to assign at the ticketing server module the selected PIN and the OTP result to the right customer reference).

In step (13) the PIN is stored at the ticketing server module data base, together with the keys and parameters to calculate a PIN-based OTP result. All this storage is labelled in FIG. 1.c data base as “OTP(PIN)” data. So that the links and storage at the data base are now the following: customer reference [symbol] A [symbol] VMC(A)ᵢ, i=1 . . . n [symbol] AC [symbol] hash(ID&AC) [symbol] OTP(PIN).

Still in step (13), the ticketing server module calculates an OTP result using the stored user PIN and OTP keys and parameters, and compares the result with the one received from the mobile phone ticketing application. If validation is successful then ticketing credentials can be sent to the mobile phone ticketing application. So the ticketing server module send credentials to the registered user mobile phone after successful validation of a One Time Password (OTP) received from the mobile phone ticketing application.

In step (14) a first set of credentials (e.g. credentials from i=1 to i=j, j<n) are sent to the mobile phone ticketing application; the user mobile phone receives the credentials and stores them for use at the transportation contactless ticketing system (so card “A” personalization process is then completed to use credentials i=1 to i=j).

The registered user can in step (15) use the mobile phone to access to transportation services. In step (15) the user shall insert his PIN code at the mobile phone ticketing application before trying to access to the ticketing access control system 400; so mobile phone enablement for each contactless ticketing access also requires the user inserting a personal identity code (PIN) at the mobile phone ticketing application.

In step (16) the ticketing server module is aware that a first set of ticketing credentials have been successfully received and stored at the mobile phone ticketing application (success on step 14) so confirmation is sent to the web distributor, that makes payment final charge and inform the user (e.g. via an SMS or a distributor web page alert).

New credentials are sent to the mobile phone application when successively requested from the user mobile device, up to the limit of the granted right to use contactless ticketing services.

In step (17) the credentials module of the mobile phone ticketing application detects that new credentials are required and send a request_credentials message to the ticketing server module. This message contains a One-Time-Password (OTP) result, calculated using the PIN value (and the Activation Code and hash(AC&ID) values, to be able to assign at the ticketing server module the OTP result to the right customer reference). In one embodiment the application calculates the OTP taking advantage of the user inserting his PIN code when trying to access to the ticketing transportation system. In other embodiment the user is prompted to insert his PIN code in order the OTP result will be calculated.

As in the second part of step (13), the ticketing server module calculates an OTP result using the stored user PIN and OTP keys and parameters, and compares the result with the one received from the mobile phone ticketing application. If validation is successful then more ticketing credentials can be sent to the mobile phone ticketing application. So the ticketing server module send more credentials to the registered user mobile phone after successful validation of a One Time Password (OTP) received from the mobile phone ticketing application.

In step (18), a new set of credentials (e.g. credentials from i=j+1 to i=k, k<n) are sent to the mobile phone ticketing application; the user mobile phone receives the credentials and stores them for use at the transportation contactless ticketing system (so card “A” personalization process is then completed to use credentials i=j+1 to i=k).

In this embodiment steps (17), (13) and (18) are repeated until credentials up to credential i=n are sent to the mobile phone, and are received and stored at the mobile phone ticketing application for use at the transportation contactless ticketing system.

All these credentials, up to credential n, can be used in step (15) by the registered user to access to transportation services. In step (15) the user shall insert his PIN code at the mobile phone ticketing application before trying to access to the ticketing access control system 400; so mobile phone enablement for each contactless ticketing access also requires the user inserting a personal identity code (PIN) at the mobile phone ticketing application.

The right to use ticketing services can be extended by the user paying for it, so new ticketing right partitions can be dynamically generated at the ticketing server module. So e.g. after a new execution of steps (2) and (3), partitions from i=n+1 to i=m can be generated in a new execution of step (4) process, and credential from i=n+1 to i=m can be successively sent to the mobile phone and received and stored at the mobile phone ticketing application according by repeated steps (17), (13) and (18) for use at the transportation contactless ticketing system.

In a particular example the user pays 50 [symbol] via the web distribution channel and the granted transportation right allows him to access to Zone A bus ticketing services during the month of April (30 days). The ticketing server module prepares credential 1 for use on the first day of the month . . . and credential 30 for use on the last day of the month. First five credentials are sent to the mobile phone application before starting the month, after receiving a right OTP value; in case there are still mobile phone available credentials for four remaining days, the request_credentials message is sent to request credentials for 1 extra day, taking advantage of the user inserting the PIN to access to mobile ticketing services; in case there will be available credentials for three remaining days, the request will be for 2 extra days, taking advantage of the user inserting the PIN to access to mobile ticketing services; in case there will be available credentials for 2 or just 1 day, the user will be prompted to insert his PIN code at the mobile phone ticketing application in order new credentials will be requested, received and stored (up to the limit of 5 days credentials available at the mobile phone).

In another particular example the user pays 40 [symbol] via the web distribution channel and the granted transportation right allows him for 40 bus trips within Zone A. First five credentials, one per trip, are sent to the mobile phone application, after receiving a right OTP value; in case there are still mobile phone available credentials for four remaining trips, the request_credentials message is sent to request credentials for 1 extra trip, taking advantage of the user inserting the PIN to access to mobile ticketing services; in case there will be available credentials for three remaining trips, the request will be for 2 extra trips, taking advantage of the user inserting the PIN to access to mobile ticketing services; in case there will be available credentials for 2 or just 1 trip, the user will be prompted to insert his PIN code at the mobile phone ticketing application in order new credentials will be requested, received and stored (up to the limit of 5 trips credentials available at the mobile phone).

So the mobile phone application limits the request of new credentials based on information about the credentials that are already stored into the mobile phone. Advantageously this feature allow the provider of ticketing services to monitor and control the number of credentials available at the user mobile phone, thus keeping part of the granted right at the ticketing server module.

The operations or the security module at the ticketing server module may request at least one credential to be disabled at (or deleted from) the mobile phone application by sending a disabling (or deleting) message from the ticketing server module to the user mobile phone application. So the provider of ticketing services can still manage credentials live cycle when already available at the mobile phone application.

In an embodiment, ticketing credentials are blocked at the mobile phone application after a number of wrong insertions of the Personal Identification Number, and an advice message is sent to the ticketing server module. In another embodiment the ticketing server module blocks the granted ticketing right after a number of wrong verifications of an OTP received from the mobile phone application, and a credentials blocking message is sent to the mobile phone application. Thus the provider of ticketing services has PIN and security management tools available both at the application and at the ticketing server module side.

The security module periodically checks the validity of activations codes and credentials so they cannot be used after expiration. In an example, if an activation code or credential is used after its expiration date a message is sent to the legacy transportation system to inform about this event.

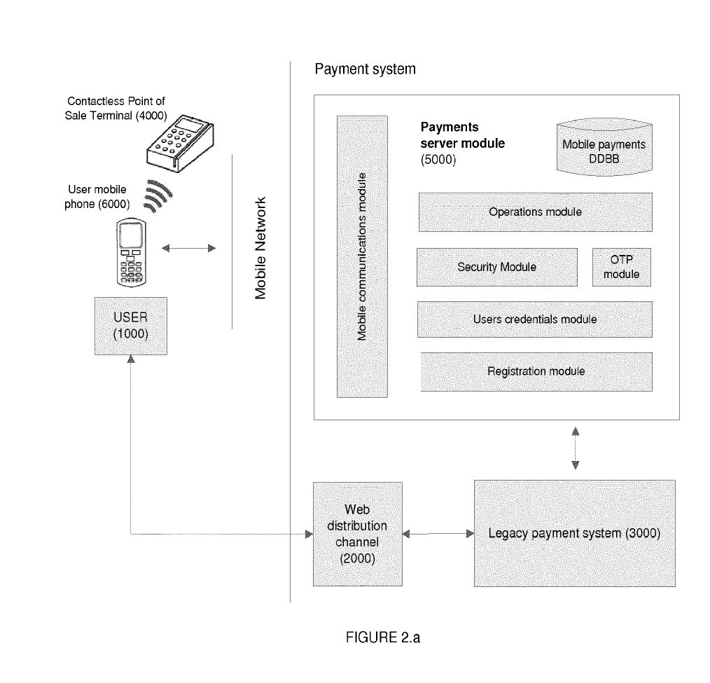

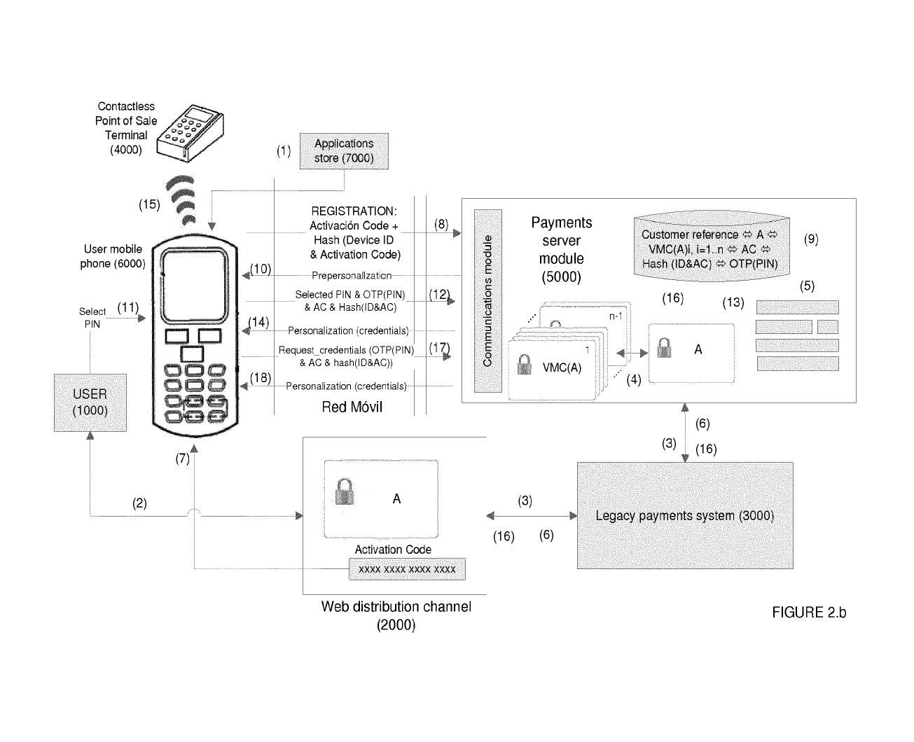

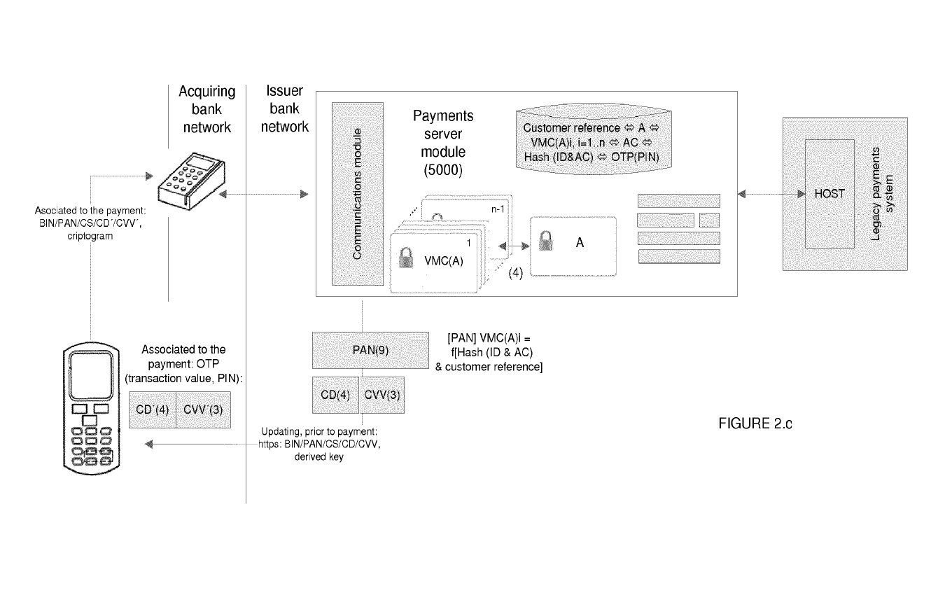

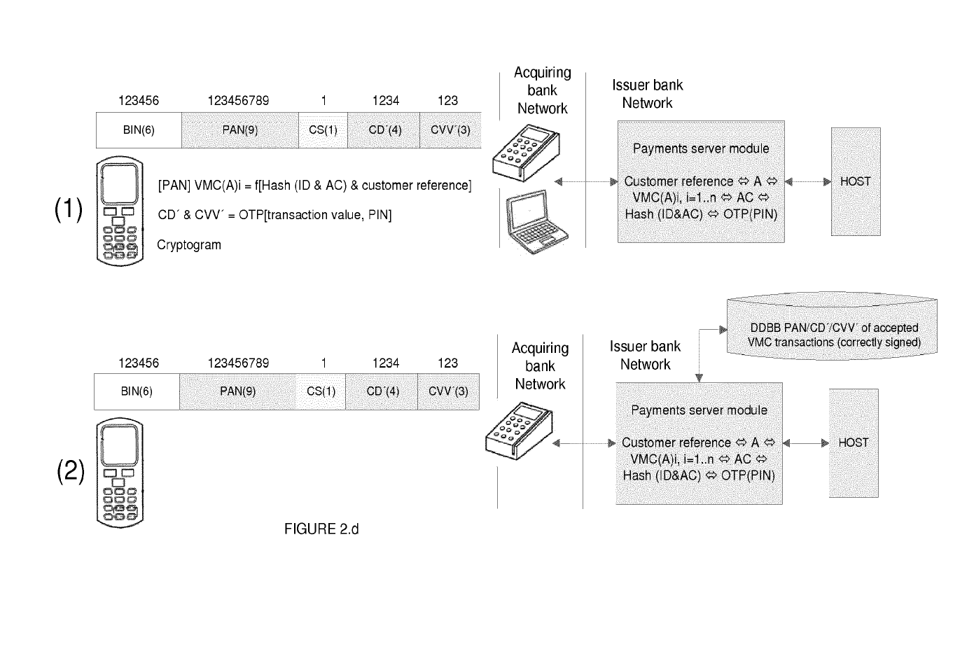

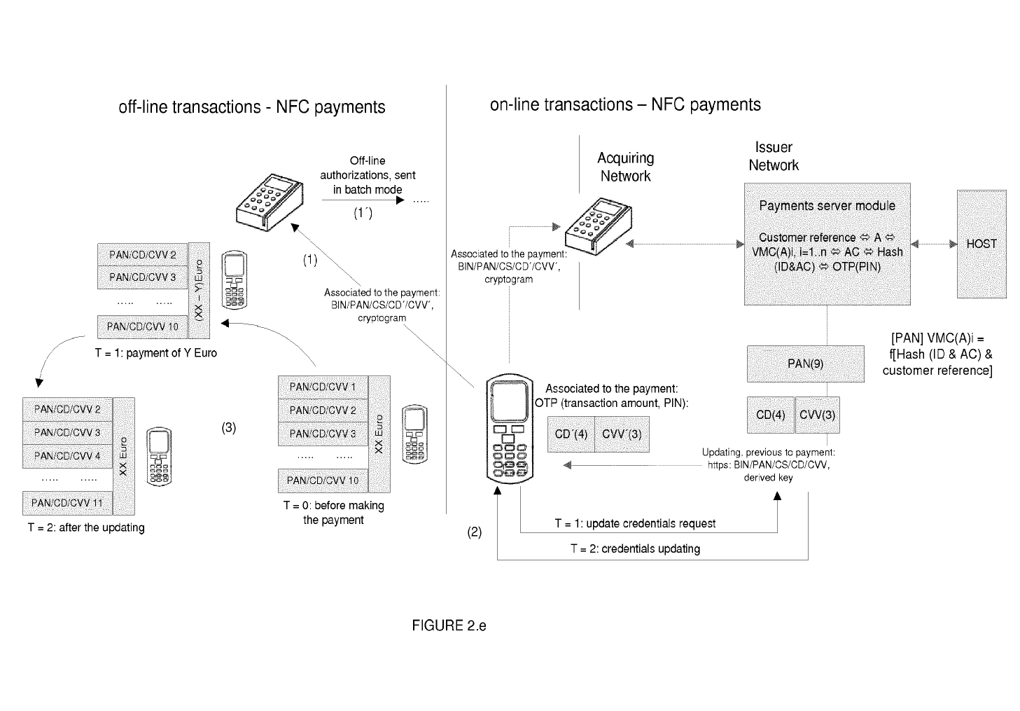

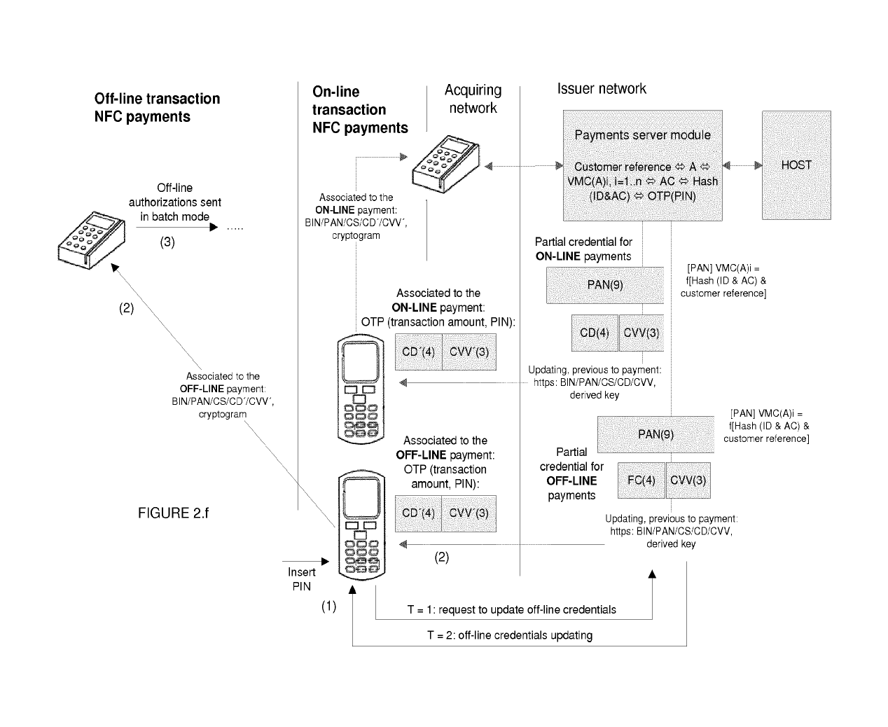

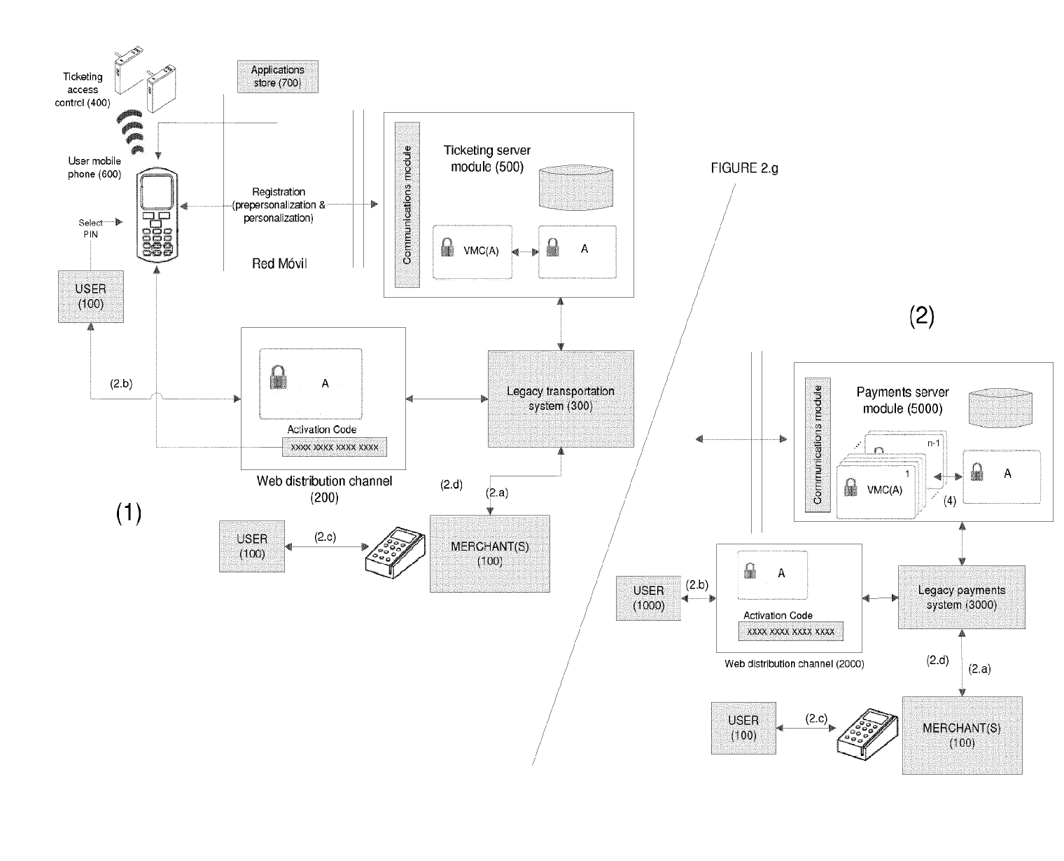

FIG. 2.a is a schematic diagram that generally illustrates the main functional blocks of the invention, as an extension of a legacy payment system; this figure shows a legacy payment system 3000a from a bank (/payments media entity) service provider, supporting contact & contactless smart cards for payments (so a user of this system may have available a contact/contactless financial smart card to pay at merchant locations equipped with a contact/contactless Point of sale Terminal 4000a). Users 1000a can request, via web distribution channel 2000a, financial smart cards for debit/credit/prepaid payments. In this example the web distribution channel belongs to the bank that owns the legacy payment system and the user is also customer is this bank, so he can confirms payment for requested financial cards and later activate them via the web page, using an electronic signature media provided by the bank.

When the user requests, via the web distribution channel, the mobile payment services related to the present invention (it is the capability to use at least one financial mobile card for mobile contactless payments) and pays for them (the user pays for the requested capability) using the bank electronic signature media, the legacy payments system forward the request to the payments server module 5000a of the invention. Main functional blocks of this module are illustrated in this figure.

FIG. 2.b provides further details about the functional blocks of FIG. 2.a and is a schematic diagram illustrating an embodiment of a payment system according to the invention, to enable mobile contactless payments via a mobile phone application; FIG. 2.b shows the process from user registration for mobile payment services up to the provision of those services.

In step (1) the user downloads the payments mobile phone application from an applications store 7000 into his contactless enabled mobile phone.

In the context of the invention, the user pays for certain payment services requested to the services provider. In step (2) of this embodiment, the user requests payment services (it is to request the capability to use at least one financial mobile card for mobile contactless payments) via a web distribution channel and confirms payment via this media (the user pays for the requested capability). In this embodiment the same scenario than the one described in FIG. 2.a applies: the web distribution channel belongs to the bank. In step (3) the request is sent to the legacy payments system and then forwarded to the payments server module.

Associated to the payment and to the corresponding granted right to use related payment services, a payments server module prepares payment credentials for use by the registered user and send them to the registered user mobile phone, as detailed herein below. In this embodiment the payments server module divides the granted payments right into several partitions and generates an independent credential for each one of those partitions.

In step (4) the payments server module assigns a payments right to the user (represented in FIG. 2.b as card “A” into the server module), linked to a set of credentials (represented in FIG. 2.b as cards “VMC(A)₁” to “VMC(A)ₙ” into the server module) and to a payments customer reference and stores these links into the payments server module database (customer reference [symbol] A [symbol] VMC(A)ᵢ, i=1 . . . n).

In step (5) an activation code is generated and stored into the payments server module database (customer reference [symbol] A [symbol] VMC(A)ᵢ, i=1 . . . n [symbol] AC). In step (6) the Activation code is sent to the legacy payments system, forwarded to the web distribution channel and displayed to the user.

In step (7) the user inserts the activation code into the mobile phone payment application and in step (8) the mobile phone sends to the payments server module, e.g. via https, the [activation code and the hash(mobile phone identity number & activation code)].

In step (9) the hash value is stored at the payments server module, so that the links are now as follows: customer reference [symbol] A [symbol] VMC(A)ᵢ, i=1 . . . n [symbol] AC [symbol] hash(ID&AC).

In step (10) card “A” is pre personalized at the mobile phone application.

Pre personalization refers to the step previous to personalization; and card “A” pre-personalization/personalization refers to pre-personalization/personalization of the mobile contactless payment application of the invention to operate in “card emulation mode” for mobile contactless payment services, equivalently to a SIM based payment application operating in “card emulation mode” for mobile contactless payment services (such as EMV chip & PIN payments). Card “A” full personalization at the mobile phone payment application requires downloading credentials from the payments server module to the mobile phone payment application, as described herein below.

When step (10) ends the user is already registered into the system of the invention, but receiving credentials at the mobile phone payment application is still pendent. At this stage, each credential is univocally associated to the registered user mobile phone and to an activation code and partly enables the mobile phone for contactless payment services at merchant locations.

In step (11) the user is prompted to select a Personal Identification Number (PIN) for mobile contactless payment services. The PIN value is not stored at the mobile phone payment application but is securely sent in step (12) to the payments server module, together with a One-Time-Password (OTP) calculated using the PIN value (and the Activation Code and hash(AC&ID) values, to be able to assign at the payments server module the selected PIN and the OTP result to the right customer reference).

In step (13) the PIN is stored at the payments server module data base, together with the keys and parameters to calculate a PIN-based OTP result. All this storage is labelled in FIG. 1.c data base as “OTP(PIN)” data. So that the links and storage at the data base are now the following: customer reference [symbol] A [symbol] VMC(A)ᵢ, i=1 . . . n [symbol] AC [symbol] hash(ID&AC [symbol] OTP(PIN).

Still in step (13), the payments server module calculates an OTP result using the stored user PIN and OTP keys and parameters, and compares the result with the one received from the mobile phone payment application. If validation is successful then payment credentials can be sent to the mobile phone payment application. So the payments server module send credentials to the registered user mobile phone after successful validation of a One Time Password (OTP) received from the mobile phone payment application.

In step (14) a first set of credentials (e.g. credentials from i=1 to i=j, j<n) are sent to the mobile phone payment application; the user mobile phone receives the credentials and stores them for use at merchant locations equipped with contactless Point of Sale Terminals (so card “A” personalization process is then completed to use credentials i=1 to i=j).

The registered user can in step (15) use the mobile phone to pay at merchants equipped with contactless Point of Sale Terminals. In step (15) the user shall insert his PIN code at the mobile phone payment application before trying to pay at the contactless Point of Sale Terminal 4000; so mobile phone enablement for each contactless mobile payment also requires the user inserting a personal identity code (PIN) at the mobile phone payment application.

In step (16) the payments server module is aware that a first set of payment credentials have been successfully received and stored at the mobile phone payment application (success on step 14) so confirmation is sent to the web distributor, that makes payment final charge and inform the user (e.g. via an SMS or a distributor web page alert).

New credentials are sent to the mobile phone application when successively requested from the user mobile device, up to the limit of the granted right to use contactless payment services.

In step (17) the mobile phone payment application detects that new credentials are required and send a request_credentials message to the payments server module. This message contains a One-Time-Password (OTP) result, calculated using the PIN value (and the Activation Code and hash(AC&ID) values, to be able to assign at the payments server module the OTP result to the right customer reference). In one embodiment the application calculates the OTP taking advantage of the user inserting his PIN code when trying to make a mobile contactless payment at a merchant location. In other embodiment the user is prompted to insert his PIN code in order the OTP result will be calculated.

As in the second part of step (13), the payments server module calculates an OTP result using the stored user PIN and OTP keys and parameters, and compares the result with the one received from the mobile phone payment application. If validation is successful then more payment credentials can be sent to the mobile phone payment application. So the payments server module send more credentials to the registered user mobile phone after successful validation of a One Time Password (OTP) received from the mobile phone payment application.

In step (18), a new set of credentials (e.g. credentials from i=j+1 to i=k, k<n) are sent to the mobile phone payment application; the user mobile phone receives the credentials and stores them for use on contactless mobile payments (so card “A” personalization process is then completed to use credentials i=j+1 to i=k).

In this embodiment steps (17), (13) and (18) are repeated until credentials up to credential i=n are sent to the mobile phone, and are received and stored at the mobile phone payment application for use on contactless mobile payments.

All these credentials, up to credential n, can be used in step (15) by the registered user for contactless mobile payments. In step (15) the user shall insert his PIN code at the mobile phone payment application before trying to pay at the merchant contactless Point of Sale Terminal; so mobile phone enablement for each contactless mobile payment also requires the user inserting a personal identity code (PIN) at the mobile phone payment application.

The right to use payment services can be extended by the user paying for it, so new payment right partitions can be dynamically generated at the payments server module. So e.g. after a new execution of steps (2) and (3), partitions from i=n+1 to i=m can be generated in a new execution of step (4) process, and credential from i=n+1 to i=m can be successively sent to the mobile phone and received and stored at the mobile phone payment application according by repeated steps (17), (13) and (18) for use on mobile contactless payments.

In a particular example the user pays 20 [symbol] via the web distribution channel and the granted payment right enables him to perform contactless payments operations, via his mobile contactless application, and according to a traditional credit product scheme, at merchant contactless Point of Sale Terminals during 1 year. The payments server module prepares credentials for use during the yearly period, each one only valid for a single payment attempt. First five credentials are sent to the mobile phone application when starting the period, after receiving a right OTP value; in case there are still mobile phone available credentials for four remaining payment operations, the request_credentials message is sent to request credentials for 1 extra payment, taking advantage of the user inserting the PIN for a mobile contactless payment attempt at a merchant location; in case there will be available credentials for three remaining payment operations, the request will be for 2 extra payments, taking advantage of the user inserting the PIN for a mobile contactless payment attempt at a merchant location; in case there will be available credentials for 2 or just 1 payment operation, the user will be prompted to insert his PIN code at the mobile phone payment application in order new credentials will be requested, received and stored (up to the limit of 5 payment credentials available at the mobile phone).

So the mobile phone application limits the request of new credentials based on information about the credentials that are already stored into the mobile phone. Advantageously this feature allow the provider of payment services to monitor and control the number of credentials available at the user mobile phone, thus keeping part of the granted right at the payments server module.

The operations or the security module at the payments server module may request at least one credential to be disabled at (or deleted from) the mobile phone application by sending a disabling (or deleting) message from the payments server module to the user mobile phone application. So the provider of payment services can still manage credentials live cycle when already available at the mobile phone application.

In an embodiment, payment credentials are blocked at the mobile phone application after a number of wrong insertions of the Personal Identification Number, and an advice message is sent to the payments server module. In another embodiment the payments server module blocks the granted payments right after a number of wrong verifications of an OTP received from the mobile phone application, and a credentials blocking message is sent to the mobile phone application. Thus the provider of payment services has PIN and security management tools available both at the application and at the payments server module side.

FIG. 2.c is a flow chart illustrating partly an embodiment of a method according to the invention.

In this embodiment, for on-line mobile contactless payment transactions, a second part of the payment credential is calculated by the mobile phone payment application itself, using the transaction value and the user PIN as inputs to generate an OTP result (the second part of the credential). The first and the second part of the credential are used for the mobile contactless payment transaction and verification of such OTP by the payment server module is required in order to accept or deny the transaction.

In another embodiment for on-line mobile contactless payment transactions a second part of the credential is calculated by the mobile phone application itself, using the user PIN as input to generate a OTP result being the second part of the credential. The first and the second part of the credential are used for the mobile contactless payment transaction and verification of such OTP by the payment server module is required in order to accept or deny the transaction.

In an EMV chip & PIN environment a PAN number is assigned to an EMV card provided to the user (card (A)). This card includes another set of data that are part of the credential itself: caducity date (CD), CVV and derived key for cryptogram calculation.

In this embodiment the payment credential for card VMC(A)ᵢ is first generated at the payments server module, so the PAN, CD, CVV and derived key are calculated at server side and sent, together with the BIN, to the mobile payments application. In a particular example, the PAN number is generated using the hash(ID&AC) and the customer reference as input data.

During the on-line payment process that uses this VMC(A)ᵢ payment credential, the PIN is inserted at the mobile phone payment application. In this embodiment the transaction value (the payment amount) is also inserted by the user at the mobile phone payment application so that both the transaction value and the user PIN are inputs to generate an OTP result (the second part of the credential). In a particular example the OTP is a 7 digits result, CD′ (4 digits) and CVV′ (3 digits). CD′ shall be a valid caducity date at the payments media system.

The contactless payment transaction attempt is performed using BIN/PAN/CD′/CVV′ and the cryptogram as credentials so that the first part of the credential has been calculated at server side and the second part at the mobile phone payment application, using the PIN and the transaction value as input data.

The payments server module processes the received PAN and obtains customer & device reference data, so that it can assigns the transaction to a particular account (PIN, OTP keys, etc). In the context of an on-line transaction the transaction value is know at the server side and the PIN is stored at the payments server module so the OTP can be verified by the payments server module. If OTP verification is successful the credentials are validated and the transaction can be authorized at the bank host as being a card (A) transaction. Response messages to the acquiring bank will nevertheless refer to a VMC(A)ᵢ transaction.

Advantageously calculating part of the credential at the mobile phone payments application provides the user and the system a higher level of security on payment credentials live cycle.

FIG. 2.d is a flow chart illustrating partly an embodiment of a method according to the invention. The first part of the graphic shows a mobile contactless on-line payment (1) as the one described in FIG. 2.c, where the first part of a credential is constituted by BIN/PAN/CS/CD/CVV & the derived key and the second part relates to the CD′ & CVV′ values calculated at the mobile (the cryptogram is calculated based on the derived key).

In the context of this embodiment, such mobile contactless on-line payment transaction (1) that uses the first and the second part of the credential has already been accepted (“the first transaction”) and at least one additional transaction (2) that later uses at least part of the same first and second part of the credential (“the successive transactions”) is accepted based on the OTP verification of the first transaction.

FIG. 2.d also illustrated a DDBB of PAN/CD′/CVV′ values of previously accepted mobile contactless on-line payment transactions, that servers for the purpose of tracking whether a particular transaction is a successive one or not. So each of the successive transactions are matched to the first transaction based on the use of the at least part of the first and the second part of the credential.

In other particular embodiment each of the successive transactions are matched to the first transaction based on the use of the at least part of the first and the second part of the credential and the use of at least one additional parameter, this parameter being included in the transaction flow of the first and the successive transactions. In a particular example the at least one additional parameter is the merchant code. So in this embodiment the DDBB of previously accepted MVC transactions must also include the referred at least one additional parameter.

Sometimes, a credential necessary for an internet payment is a subset of the credential required for a mobile contactless payment so it would be possible to perform an internet payment using such a subset.

In an embodiment the user selects through his mobile phone payment application to make an internet payment and the second part of the credential (CD′ & CVV′ values in FIG. 2.d.1) together with at least a part of the first part of the credential (the BIN/PAN/CS in FIG. 2.d.1) are used to perform such payment.

The same logic already described in FIG. 2.d for mobile contactless on-line payments, related to accepting successive transactions of the basis of the verified electronic signature of a first transaction, can also be applied to internet payments. So in an embodiment, an internet transaction that uses at least a part of the first part of the credential and the second part of the credential has already been accepted (“the first transaction”) and at least one additional transaction that later uses the same at least a part of the first part of the credential and the second part of the credential (“the successive transactions”) is accepted based on the OTP verification of the first transaction.

In a particular embodiment each one of the successive transactions is linked to the first transaction based on the use of the at least a part of the first part of the credential and the second part of the credential. In another embodiment at least an additional parameter could be added to make the matching process more efficient, being this parameter included into the transaction flow of the first and the successive transactions.

FIG. 2.e is a flow chart illustrating partly an embodiment of a method for mobile contactless off-line payments according to the invention.

This diagram shows a predefined maximum number of (10) credentials stored into the mobile phone at a given time and the mobile phone application limits mobile contactless off-line payments using those credentials up to maximum off-line payments aggregated transaction value. So making off-line payments for an aggregated higher value requires the user correctly inserting the PIN value, such that the payments server module will send new credentials to the registered user mobile phone and the mobile phone payment application will set again the off-line payments aggregated transaction value to the maximum.

Steps (1) and (1′) illustrates the user making a mobile contactless off-line payment and the authorization being sent to the payments server module in batch mode. So for mobile contactless off-line transactions, the payments server module verifies the OTP a posteriori.

In step (2) a credentials updating process may performed, taking advantage that the user has inserted the PIN value in connection to a payment. If the PIN value is not correct the credentials updating process will not take place.

The available credentials at T=0 are associated to a maximum amount value for mobile contactless off-line payments. Step (3) shows how the maximum amount value for mobile contactless off-line payments decrease to (XX−Y) euro after a payments at T=1 and how the available amount value for off-line payments is updated to the maximum value of X euro after a successful credentials updating process (result of a correct PIN value insertion at the mobile by the user).

FIG. 2.f is a flow chart illustrating partly another embodiment of a method for mobile contactless off-line payments according to the invention.

In this embodiment there is a maximum predefined number of the first part of a set of credentials for mobile contactless off-line payments that can be stored into the mobile phone at a given time instant and, once the validity period of the first part of each one of those credentials expires, the mobile phone payment application limits the mobile contactless off-line payments that uses that first part of each one of those credentials. So, to perform mobile contactless off-line payments once that first part of the set of credentials for mobile contactless off-line payments has expired, the user must correctly insert the PIN value, such that the payments server module will send new valid first parts of credentials for mobile contactless off-line payments to the registered user mobile phone.

Step (1) illustrates the user inserting the PIN to request the first part of a set of credentials for mobile contactless off-line payments. The OTP(PIN) value is verified and, if correct, those partly calculated credentials are downloaded to the mobile. In a particular example only one credential will be downloaded, with a validity of few minutes.

Process (2) shows a mobile contactless off-line payment. The user inserts the PIN via the mobile payment application and wave the mobile close to the merchant Point of Sale Terminal (POS). The mobile payment application then receives from the POS the transaction amount and the type of transaction (off-line), selects a partly calculated credential for off-line payments and calculates the OTP(transaction amount, PIN) and the cryptogram for the off-line payment.

In step (3) the mobile contactless off-line transactions are sent to the payments server module in batch mode. As the user has been prompted to insert again the PIN in process (2), the payments server module will be able to verify the PIN a posteriori.

FIG. 2.g is a flow chart illustrating partly an embodiment of a method according to the invention, and provides an alternative method for the user to pay to the service provider for certain ticketing/payment services.

FIG. 2.g.1 slightly modifies the process described in connection to FIG. 1.b such that step (2) is now divided in steps (2.a) to (2.d). In step (2.a) one or several merchants pay “on behalf of the user” to the provider of ticketing services for certain ticketing services for the user, in the context of a loyalty program offered by the merchant(s), In a particular example the merchant(s) pays for the transportation right represented as card “A” into the server module and the VMC(A) credential is then generated by the ticketing server module.

In step (2.b) the user request (already paid) ticketing services via web distribution channel and the process continues as described in connection to FIG. 1.b.

Later on the user pays for certain products and/or services at one or several associated merchants (step (2.c)), and the at least one merchant transfers part of those transactions amounts to the provider of ticketing services (step (2.d)) in order this one will offer certain ticketing services to the user. In a particular implementation the accumulated transactions amounts are used to grant the user rights for new VMC(A) credentials. So, thanks to a loyalty program addressed to pay ticketing rights on behalf of the user, the user will be able to use his mobile phone ticketing application to access to ticketing services at a multiplicity of access points (e.g. to access to any city bus).

Equivalently, FIG. 2.g.2 modifies the process described in connection to FIG. 2.b such that step (2) is now divided in steps (2.a) to (2.d). In step (2.a) one or several merchants pay “on behalf of the user” to the provider of payment services for certain payment services for the user, in the context of a loyalty program offered by the merchant(s), In a particular example the merchant(s) pays for the payments right represented as card “A” into the server module and the VMC(A)i credentials are then generated by the payments server module.

In step (2.b) the user request (already paid) payment services via web distribution channel and the process continues as described in connection to FIG. 2.b.

Later on the user pays for certain products and/or services at one or several associated merchants (step (2.c)), and the at least one merchant transfers part of those transactions amounts to the provider of payment services (step (2.d)) in order this one will offer certain payment services to the user. In a particular implementation the user can utilize his mobile phone payment application to pay at merchants up to the limit of the transactions amounts accumulated as a result of the different purchases at the at least one merchant. So through this embodiment the user can pay at any merchant supporting mobile contactless payments (instead of using close loop loyalty point in a reduced set of associated merchants).

Although the present invention has been described in detail for purpose of illustration, it is understood that such detail is solely for that purpose, and variations can be made therein by those skilled in the art without departing from the scope of the invention. Thus, while the preferred embodiments of the method and of the mobile system have been described in reference to the environment in which they were developed, they are merely illustrative of the principles of the invention. Other embodiments and configurations may be devised without departing from the scope of the appended claims.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program. For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means. When the program is embodied in a signal which may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

1-26. (canceled)

27. A method to enable mobile contactless ticketing/payments via a mobile phone application, the method comprising the following steps:
(a) a user pays to a service provider for ticketing/payment services;
(b) associated to the payment and to a corresponding granted right to use related ticketing/payment services, a ticketing/payments server module prepares one or more ticketing/payment credentials for use by the user and sends one or more ticketing/payment credentials to the user's mobile phone;
(c) the user's mobile phone receives the one or more credentials and stores them for use at a transportation contactless ticketing system, in case of ticketing credentials, or for use on mobile contactless payments, in case of payment credentials;
said method being characterized in that each credential prepared is univocally associated to the registered user's mobile phone and partly enables the mobile phone for contactless ticketing access, in case of ticketing credentials, or for mobile contactless payments, in case of payment credentials; where mobile phone enablement for each contactless ticketing access or mobile contactless payment also requires the user inserting a personal identification number (PIN) at the mobile phone ticketing/payment application; and credentials are sent to the mobile phone application, up to the limit of the granted right to use contactless ticketing/payment services.

28. A method according to claim 27, where the PIN insertion by the user is used to calculate at least part of the ticketing/payment credential used in the context of a given mobile contactless ticketing access/payment.

29. A method according to claim 27, where at least part of the ticketing/payment credentials received and stored in the mobile phone comprises a key that is later used to calculate at least part of the ticketing/payment credential used in the context of a given mobile contactless ticketing access/payment.

30. A method according to claim 27, where at least one credential is univocally associated to an activation code.

31. A method according to claim 27, where credentials are sent to the mobile phone application after being requested from the user mobile device.

32. A method according to claim 27, where the user is prompted to insert a PIN code at the mobile phone application in order new credentials will be requested to the ticketing/payments server module, and be later received and stored in the mobile phone.

33. A method according to claim 27, where the ticketing/payments server module send credentials to the registered user mobile phone after successful validation of a PIN that has been inserted by the user in the mobile phone.

34. A method according to claim 27, where the ticketing/payments server module send credentials to the registered user mobile phone after successful validation of a One Time Password (OTP) received from the mobile phone ticketing/payments application.

35. A method according to claim 27, where the ticketing/payments server module divides the granted ticketing/payment right into several partitions and generates an independent credential for each one of those partitions.

36. A method according to claim 27, where a first set of credentials is sent to the mobile phone application, and new credentials are sent to the mobile phone application when successively requested from the user mobile device, up to the limit of the granted right to use contactless ticketing/payment services.

37. A method according to claim 27, where at least one credential is disabled at, or deleted from, the mobile phone application by sending a disabling, or deleting, message from the ticketing/payments server module to the user mobile phone application.

38. A method according to claim 27, where the right to use ticketing/payment services can be extended by the user paying for it, so new ticketing/payment right partitions can be dynamically generated at the ticketing/payments server module.

39. A method according to claim 31, where the mobile phone application limits the request of new credentials based on information about the credentials that are already stored into the mobile phone.

40. A method according to claim 27, where ticketing/payment credentials are blocked at the mobile phone application after a number of wrong insertions of the Personal Identification Number, and an advice message is sent to the ticketing/payments server module.

41. A method according to claim 27, where the ticketing/payments server module blocks the granted ticketing/payments right after a number of wrong verifications of an OTP received from the mobile phone application, and a credentials blocking message is sent to the mobile phone application.

42. A method according to claim 27, where for on-line mobile contactless payment transactions a second part of the credential is calculated by the mobile phone application itself, using the transaction value and the user PIN as inputs to generate a OTP result being the second part of the credential, where the first and the second part of the credential are used for the mobile contactless payment transaction and verification of such OTP by the payment server module is required in order to accept or deny the transaction.

43. A method according to claim 27, where for on-line mobile contactless payment transactions a second part of the credential is calculated by the mobile phone application itself, using the user PIN as input to generate a OTP result being the second part of the credential, where the first and the second part of the credential are used for the mobile contactless payment transaction and verification of such OTP by the payment server module is required in order to accept or deny the transaction.

44. A method according to claim 27 or 43, where credentials have been ciphered in the ticketing/payments server module using the PIN, so mobile phone enablement for a contactless ticketing access or mobile contactless payment also requires the user inserting a PIN at the mobile phone ticketing/payment application.

45. A method according to claim 43, where a mobile contactless on-line payment transaction that uses the first and the second part of the credential has already been accepted (“the first transaction”) and at least one additional transaction that later uses at least part of the same first and second part of the credential (“the successive transactions”) is accepted based on the OTP verification of the first transaction.

46. A method according to claim 45, where each of the successive transactions are matched to the first transaction based on the use of the at least part of the first and the second part of the credential.

47. A method according to claim 45, where each of the successive transactions are matched to the first transaction based on the use of the at least part of the first and the second part of the credential and the use of at least one additional parameter, this parameter being included in the transaction flow of the first and the successive transactions.

48. A method according to claim 27, where there are a predefined maximum number of credentials stored into the mobile phone at a given time and the mobile phone payment application limits mobile contactless off-line payments using those credentials up to maximum off-line payments aggregated transaction value.

49. A method according to claim 43, where the user selects through his mobile phone payment application to make an internet payment and the second part of the credential together with at least a part of the first part of the credential are used to perform such payment.

50. A method according to claim 49, where an internet transaction that uses at least a part of the first part of the credential and the second part of the credential has already been accepted (“the first transaction”) and at least one additional transaction that later uses the same at least a part of the first part of the credential and the second part of the credential (“the successive transactions”) is accepted based on the OTP verification of the first transaction.

51. A method according to claim 50, where each one of the successive transactions is linked to the first transaction based on the use of the at least a part of the first part of the credential and the second part of the credential.

52. A method according to claim 50, where each one of the successive transactions is linked to the first transaction based on the use of the at least a part of the first part of the credential and the second part of the credential and the use of at least an additional parameter, being this parameter included into the transaction flow of the first and the successive transactions.

53. A method according to claim 27, where the user pays for certain products and/or services at one or several associated merchants, and the at least one merchant transfers part of those transactions amounts to the provider of ticketing/payments services, that associates the transferred transactions amounts to credentials that partly enable the mobile phone for contactless ticketing access, in case of ticketing credentials, or for mobile contactless payments, in case of payment credentials.

54. A method according to claim 53, where the one or several merchants pay to the provider of ticketing/payment services for certain ticketing/payment services for the user.

55. A method according to claim 27, where there is a maximum predefined number of the first part of a set of credentials for mobile contactless off-line payments that can be stored into the mobile phone at a given time instant and, once the validity period of the first part of each one of those credentials expires, the mobile phone payment application limits the mobile contactless off-line payments that uses that first part of each one of those credentials.

56. Computer program comprising program instructions for causing a computer to carry out the method of claim 27.

57. Computer program according to claim 56, incorporated in a storing medium.

58. Computer program according to claim 56, supported in a carrier signal.

59-73. (canceled)
